(19) United States
(12) Patent Application Publication
(10) Pub. No.: US 2010/0087196 A1
(43) Pub. Date: Apr. 8, 2010

(54) METHOD OF DEREGISTERING RELAY STATION AND MULTI-HOP RELAY SYSTEM FOR THE METHOD

(75) Inventors: Yong-Su Lee, Seoul (KR); Woosin Lee, Daejeon-city (KR); Young-Uk Chung, Daejeon-city (KR); Hyukjoon Lee, Daejeon-city (KR); Yong-Hoon Choi, Daejeon-city (KR); Young-II Kim, Daejeon-city (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon-city (KR)

(21) Appl. No.: 12/522,447

(22) PCT Filed: Jan. 7, 2008
(86) PCT No.: PCT/KR2008/000065

§ 371 Date: Jul. 8, 2009

(30) Foreign Application Priority Data
Jan. 8, 2007 (KR) 10-2007-0001953
Apr. 10, 2007 (KR) 10-2007-0035306
Aug. 24, 2007 (KR) 10-2007-0085633

(51) Int. Cl. H04W 36/00

(52) U.S. Cl. 455/436

(57) ABSTRACT

A method of deregistering a relay station and a multi-hop relay system for the method are provided. In order to deregister the relay station, a base station ends a handover of mobile stations connected to the relay station, and informs the relay station accordingly. When the handover of the mobile stations is ended, the relay station performs a deregistration procedure. Messages that already exist are used as messages necessary for the method.

### CROSS-REFERENCE TO RELATED PATENT APPLICATION

This application claims the benefit of Korean Patent Application Nos. 10-2007-0001953, filed on Jan. 8, 2007, 10-2007-0035306, filed on Apr. 10, 2007, and 10-2007-0085633, filed on Aug. 24, 2007 in the Korean Intellectual Property Office, the disclosures of which are incorporated herein their entirety by reference.

### BACKGROUND OF THE INVENTION

1. Field of the Invention

The present invention relates to a method of controlling a handover in a multi-hop relay network, and more particularly, to a method of performing a handover of mobile stations connected to a relay station, and deregistering the relay station.

The present invention is derived from research which was supported by the ‘Information Technology (IT) Research and Development Program’ of the Ministry of Information and Communications (MIC)/the Institute for Information Technology Advancement (IITA), Republic of Korea. The project management No. is ‘2006-S-011-01, and the title is ‘Development of relay/mesh communication system for multi-hop WiBro’.

2. Description of the Related Art

A method by which a base station controls a handover of a mobile station is defined in IEEE (Institute of Electrical and Electronics Engineers) 802.16e. However, in the conventional method, in the case where a relay station is deregistered due to various conditions such as a case in which a temporary nomadic relay station having been temporarily installed and providing a service is deregistered, a mobile station connected to the relay station loses a junction that allows connection with a network, and thus the mobile station has to re-perform an initial connection setting procedure which causes inefficiency.

### SUMMARY OF THE INVENTION

The present invention provides a method of performing a handover of mobile stations and deregistering a relay station without performing an initial network connection setting procedure on the mobile stations connected to the relay station, and a multi-hop relay system for the method.

According to an aspect of the present invention, there is provided a method of ending service of a relay station in a multi-hop relay network comprising a base station, the relay station, and one or more mobile stations connected to the relay station, the method including the operations of transmitting a service end request message to the base station, wherein the transmitting is performed by the relay station; receiving a handover end message from the base station, wherein the receiving is performed by the relay station and the handover end message indicates that a handover of the one or more mobile stations connected to the relay station is ended by the base station; and performing a deregistration procedure, wherein the deregistration procedure is performed by the relay station.

According to another aspect of the present invention, there is provided a method of deregistering a relay station in a multi-hop relay network comprising a base station, the relay station, and one or more mobile stations connected to the relay station, the method including the operations of receiving a service end request message from the relay station, wherein the receiving is performed by the base station; performing a handover of the one or more mobile stations connected to the relay station, wherein the handover is performed by the base station; and transmitting a handover end message to the relay station, wherein the transmitting is performed by the base station and the handover end message indicates that performing the handover of the one or more mobile stations is ended.

According to another aspect of the present invention, there is provided a method of deregistering a relay station, the method including the operations of generating a service end request message, and transmitting the service end request message to a base station, wherein the transmitting is performed by the relay station; when the base station receives the service end request message, determining whether to accept a service end request of the relay station; when the base station accepts the service end request of the relay station, performing a handover of all mobile stations connected to the relay station, generating a handover end message indicating that performing the handover of the mobile stations is ended, and transmitting the handover end message to the relay station; and performing a deregistration procedure, wherein the deregistration procedure is performed by the relay station.

According to another aspect of the present invention, there is provided a multi-hop relay system including a relay station generating and transmitting a service end request message; and when a service end request of the relay station is accepted according to the service end request message, a base station performing a handover of all mobile stations connected to the relay station, generating a handover end message indicating that performing the handover of the mobile stations is ended, and transmitting the handover end message to the relay station, wherein, when the relay station receives the handover end message, the relay station performs a deregistration procedure.

### BRIEF DESCRIPTION OF THE DRAWINGS

The above and other features and advantages of the present invention will become more apparent by describing in detail exemplary embodiments thereof with reference to the attached drawings in which:

FIG. 1 is a flowchart of a method of controlling a handover, performed by a synchronization relay station according to an embodiment of the present invention;

FIG. 2 is a flowchart of a method of controlling a handover, performed by an asynchronization relay station according to another embodiment of the present invention;

FIG. 3 is a flowchart of a method of deregistering a relay station according to another embodiment of the present invention;

FIG. 4 illustrates a format example of an MOB_MGHO-REQ message that is a handover request message, according to an embodiment of the present invention; and

FIG. 5 illustrates a format example of an MOB_MGHO-RSP message that is a handover response message, according to another embodiment of the present invention.

### DETAILED DESCRIPTION OF THE INVENTION

Hereinafter, a type of relay station will now be first described, and then a handover method according to the present invention will be described more fully with reference to the accompanying drawings, in which exemplary embodiments of the invention are shown.

In a mobile multi-hop relay network, a relay station may have various functions according to usage purposes and needs of provider companies. A procedure for switching a handover message among a mobile station, the relay station, and a base station may differ according to available functions of the relay station. The relay station may be divided into the following four types of model, according to a structure of a broadcast frame and whether the relay station has a function for controlling a handover.

Synchronization relay station: A synchronization relay station uses a structure of a synchronous broadcast frame. When a broadcast frame of a base station is received, the received broadcast frame is relayed by using a preamble that is the same as a preamble of the received broadcast frame. A handover in a cell performed between a relay station and a base station, a base station and a relay station, and relay stations is performed by using a message defined in a communications protocol, such as a Ranging Response (RNG-RSP) message defined in IEEE (Institute of Electrical and Electronics Engineers) 802.16e. A handover between cells is performed among base stations. Therefore, the synchronization relay station does not have a separate function for controlling the handover.

Asynchronization relay station: An asynchronization relay station uses a structure of an asynchronous broadcast frame. When a broadcast frame of a base station is received, the received broadcast frame is relayed by using a preamble that is generated in the asynchronous relay station. A handover in a cell performed between a relay station and a base station, a base station and a relay station, and relay stations, and a handover between cells performed among base stations are performed by using a conventional handover method. According to a handover processing function, the asynchronization relay station is divided into two types, that are, a handover-capable relay station, and a handover-incapable relay station.

Handover-incapable relay station: In order to be consistent with a conventional communications protocol in which a lowering of system complexity, and a handover procedure between a mobile station and a base station are defined, the handover-incapable relay station does not have a separate function for controlling a handover of a mobile station, and only relays a handover message between a mobile station and a base station.

Handover-capable relay station: In order to rapidly process a handover of a mobile station, the handover-capable relay station has a function for controlling a handover, controls the handover of the mobile station by using a message defined in a conventional standard, for example, a MOB_BSHO-REQ message defined in the IEEE 802.16e, or directly processes a handover request from the mobile station.

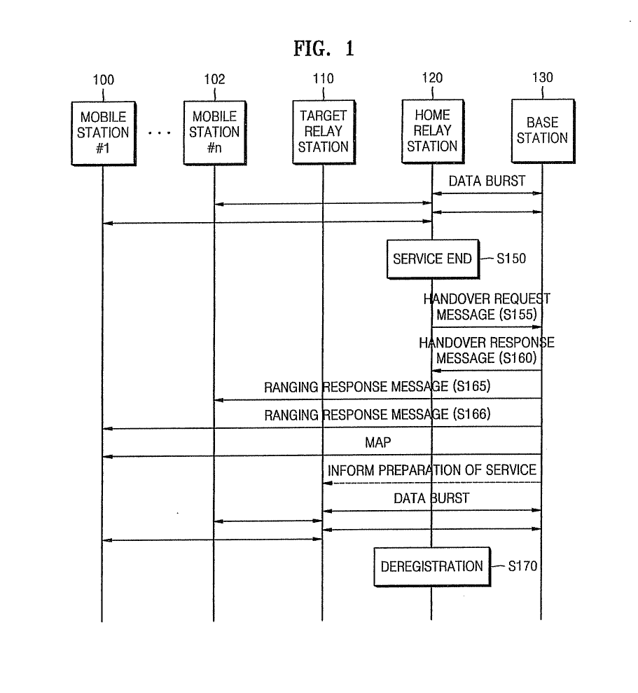

FIG. 1 is a flowchart of a method of controlling a handover, performed by a synchronization relay station according to an embodiment of the present invention.

Referring to FIG. 1, in the case where a handover of mobile stations 100 and 102 connected to a home relay station 120 is required for service-end of the home relay station 120, or for other purposes (operation S150), the home relay station 120 transmits a handover request message to a base station 130 (operation S155). The handover request message includes a handover request reason, and a list of the handover target mobile stations 100 and 102 which are subordinate mobile stations of the relay station. The handover request reasons of mobile stations are when a relay station ends its service, when link quality between a relay station and a base station is low, when resource management is required due to a change in the number of mobile stations connected to a relay station, when the number of mobile stations connected to a relay station is required to be managed so as to guarantee Quality of Service (QoS) of the mobile stations, and the like. In particular, FIG. 1 is related to the handover request reason that the relay station ends its service.

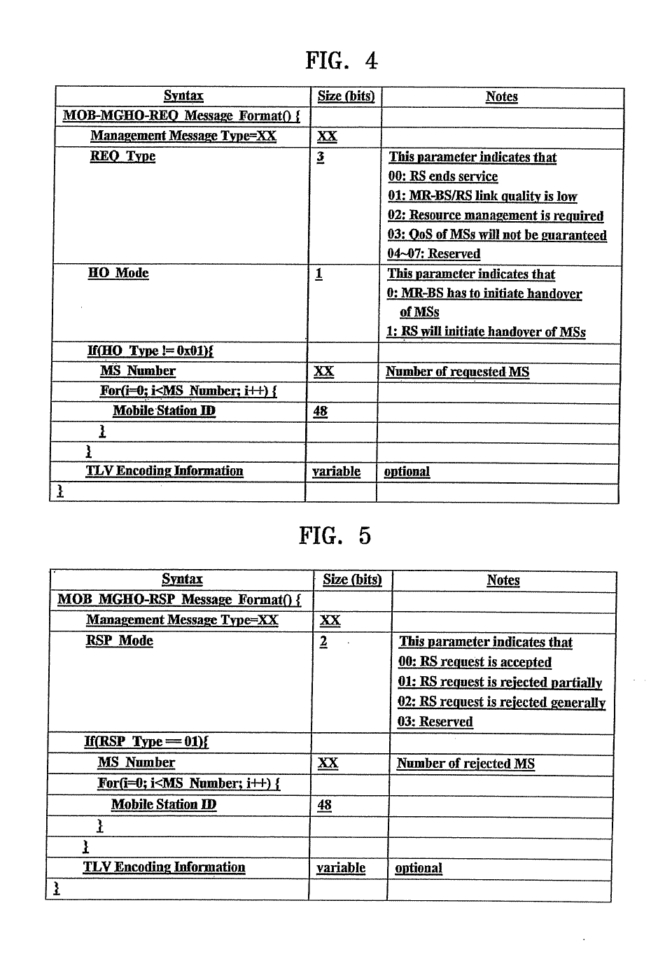

The handover request message may be defined by using not only an MOB_MSHO-REQ message defined in the conventional IEEE 802.16e but also by various other methods according to embodiments of the present invention, and may be used. An example of a newly defined message (an MOB_MGHO-REQ message) is illustrated in FIG. 4.

When the base station 130 receives the handover request message, the base station 130 generates a handover response message including information on an entire or partial acceptance of the handover request related to the mobile stations 100 and 102, or information on a rejection, and transmits the handover response message to the home relay station 120 (operation S160). The handover response message may be defined by using not only an MOB_RSHO-RSP message defined in the conventional IEEE 802.16e but also by various other methods according to embodiments of the present invention, and may be used. An example of a newly defined message (an MOB_MGHO-RSP message) is illustrated in FIG. 5.

When the home relay station 120 receives the handover response message indicating that the handover request is accepted from the base station 130, the home relay station 120 performs operations related to the handover request reason such as ending of a service (that is, ‘deregistration’), deleting information on mobile stations of a specific subnet, or the like (operation S170). When the base station 130 rejects the handover request, the home relay station 120 transmits a handover request message modified according to rejection contents included in the handover response message to the base station 130.

The base station 130 which accepted the handover request selects a new access station e.g., a target relay station 110, for the corresponding mobile stations 100 and 102, generates a ranging response message, and thereby transmits the ranging response message to the mobile stations 100 and 102 (operations S165 and S166). A RNG-RSP message defined in the conventional IEEE 802.16e may be used as the ranging response message. The mobile stations 100 and 102 which received the ranging response message connect with a network via the new access station, based on information included in the received ranging response message. Here, the term ‘ranging’ in the ranging response message refers to a processing procedure by which a base station and a mobile station maintain quality of a Radio Frequency (RF) communication connection therebetween, and is performed by using RNG-REQ and RNG-RSP messages. In a handover procedure, the ranging is used for a network re-entry procedure with a new access station (that is, a base station) to which a mobile station is to move via the handover.

MAP is a field of a Medium Access Control (MAC) frame, and includes control information for transmitting data via a downlink and an uplink. A data burst indicates massive data transmitted via allocated wireless resources.

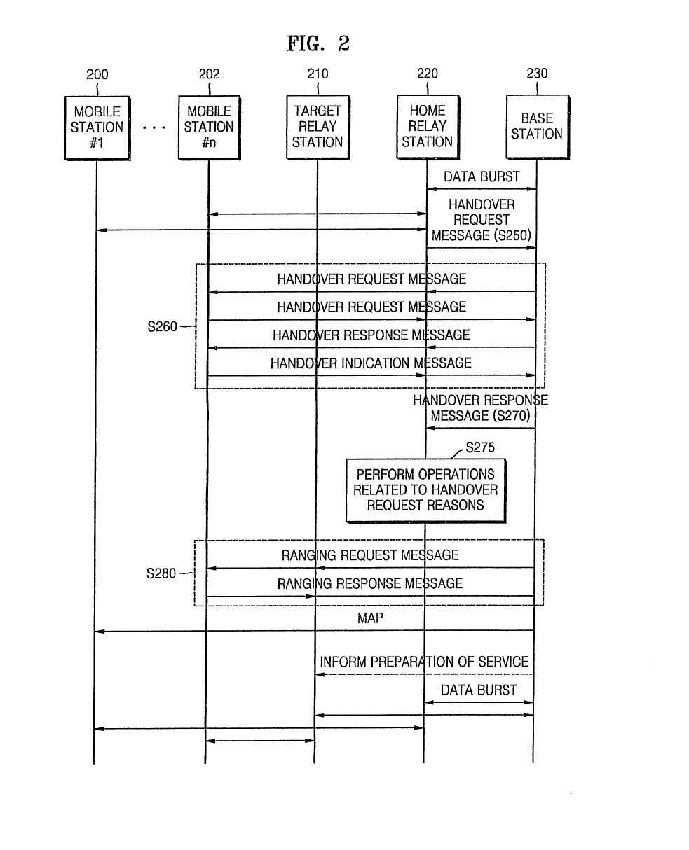

FIG. 2 is a flowchart of a method of controlling a handover, performed by an asynchronization relay station according to another embodiment of the present invention.

Referring to FIG. 2, in the case where a handover of mobile stations 200 and 202 connected to a home relay station 220 is required, the home relay station 220 transmits a handover request message including a handover request reason, and an address list of the mobile stations 200 and 202, to a base station 230. The handover request message may be defined by using not only an MOB_MSHO-REQ message defined in the conventional IEEE 802.16e but also by various other methods according to embodiments of the present invention, and may be used. An example of a newly defined message (an MOB_MGHO-REQ message) is illustrated in FIG. 4.

The handover request reasons of mobile stations are when a relay station ends its service, when link quality between a relay station and a base station is low, when resource management is required, when QoS of mobile stations is not guaranteed, and the like. FIG. 2 is related to the case that only the n^{th} mobile station 202 requires a handover.

The base station 230 performs a handover to the respective mobile stations 200 and 202, based on the address list of the mobile stations 200 and 202 included in the handover request message (operation S260). For example, when the base station 230 accepts the handover request for the n^{th} mobile station 202, the base station 230 transmits a handover request message (an MOB_BSHO-REQ message) to the n^{th} mobile station 202. The n^{th} mobile station 202 receives the handover request message (the MOB_BSHO-REQ message) from the base station 230, transmits a handover request message (an MOB_MSHO-REQ message) to the base station 230, receives a handover response message (an MOB_MSHO_RSP message) from the base station 230, transmits a handover indication message (an MOB_MSHO-IND message) to the base station 230, thereby performing a handover. In the current embodiment, the handover messages between the base station 230, and mobile stations 200 and 202 are the MOB_BSHO-REQ message, the MOB_MSHO_REQ message, the MOB_MSHO_RSP message, and the MOB_MSHO-IND message, which are defined in the conventional IEEE 802.16e, are used as an example. However, a form of the handover messages is not limited thereto but may also vary according to a communications protocol.

In the case of the asynchronization relay station, the asynchronization relay station has to relay the handover messages between the base station 230, and mobile stations 200 and 202, and thus, after a handover of all mobile stations 200 and 202 is ended, the base station 230 transmits a handover response message to the home relay station 220, wherein the handover response message includes information informing that the handover of all mobile stations 200 and 202 has been completed (operation S270). On the other hand, when the base station 230 rejects the handover request, the base station 230 transmits a handover response message including information on rejection for the handover request to the home relay station 220 (operation S270). The handover response message may be defined by using not only an MOB_RSHO-RSP message defined in the conventional IEEE 802.16e but also by various other methods according to embodiments of the present invention, and may be used. An example of a newly defined message (an MOB_MGHO-RSP message) is illustrated in FIG. 5.

When the home relay station 220 receives the handover response message including the information informing that the handover of all mobile stations 200 and 202 which have requested the handover is ended, the home relay station 220 performs operations related to the handover request reason (operation S275). For example, when a handover of mobile stations is requested whereby a relay station is to end a service, the service is ended by deregistration. When a handover of only some mobile stations is requested due to other purposes, information on the handover is deleted. On the other hand, when the handover response message indicating the handover request has been rejected is received, the home relay station 220 re-transmits the handover request message to the base station 230.

When the handover of the mobile stations 200 and 202 is ended, the base station 230 performs a ranging procedure for the mobile stations 200 and 202 via a target relay station 210 (operation S280). RNG-REQ and RNG-RSP messages defined in the IEEE 802.16e may be used as a message for the ranging procedure.

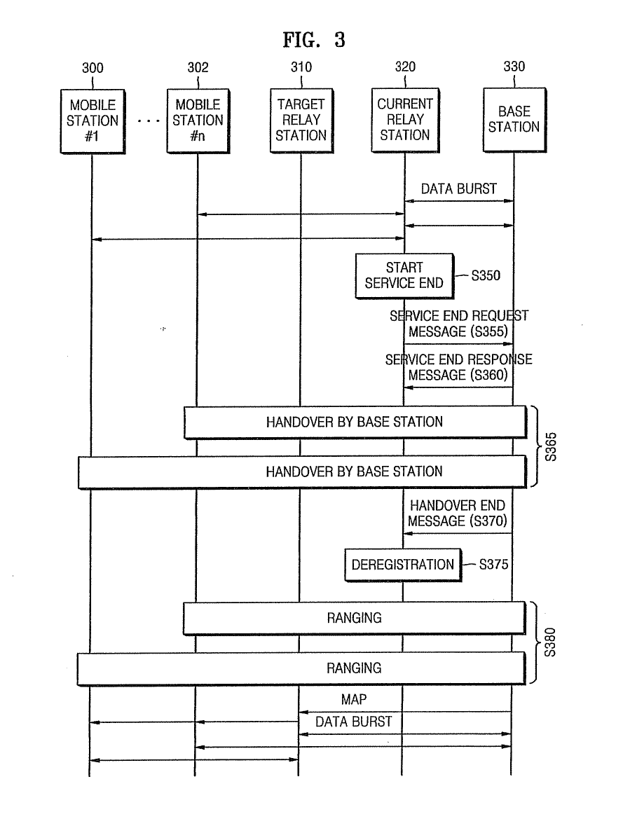

FIG. 3 is a flowchart of a method of deregistering a relay station 320 according to another embodiment of the present invention.

Referring to FIG. 3, in order to end service of the relay station 320 which currently provides a service (operation S350), all of mobile stations 300 and 302 connected to the relay station 320 have to be handed over to another relay station or base station, before deregistering the relay station 320.

For this purpose, the relay station 320 transmits a service end request message to a base station 330, wherein the service end request includes a service end request and a request for a handover of the mobile stations 300 and 302 connected to the relay station 320 (operation S355). Here, a DREG-REQ message defined in the conventional IEEE 802.16e may be used as the service end request message. For example, a new parameter for recognizing a message according to the present invention is added to an “Action Codes” field of the conventional DREG-REQ message, and is thereby used.

When the base station 330 receives the service end request message from the relay station 320, the base station 330 determines whether or not to accept the service end request from the corresponding relay station 320, and informs the relay station 320 about the result of the determination by using a service end response message (operation S360).

When the service end request from the relay station 320 is accepted, the base station 330 generates the service end response message including information informing that the service end request has been accepted, transmits the service end response message to the relay station 320 (operation S360), and performs a handover of the mobile stations 300 and 302 (operation S365). The base station 330 hands over the mobile stations 300 and 302 to the base station 330 itself, or another target relay station 310. When the handover between the base station 330, and the mobile stations 300 and 302 is ended, the base station 330 transmits a handover end message including information informing that the handover has been ended to the relay station 320, thereby enabling the relay station 320 to perform a deregistration procedure (operation S375). That is, when the relay station 320 receives the handover end message indicating that the handover has been ended, the relay station 320 starts the deregistration procedure (operation S375). The base station 330 performs a ranging procedure for the mobile stations 300 and 302 which have been handed over to the target relay station 310 (operation S380).

On the other hand, when the base station 330 rejects the service end request from the relay station 320, the base station 330 generates a service end response message including information informing that the service end request has been rejected, and transmits the service end response message to the relay station 320 (operation S360). At this time, the base station 330 sets a REQ-duration time, that is, a re-transmission time until the service end request is re-performed, and transmits the service end response message including the REQ-duration time to the relay station 320. When the relay station 320 receives the service end response message indicating that the service end request has been rejected, the relay station 320 keeps performing its original functions, and then after a predetermined time (that is, after the set REQ-duration time), re-transmits the service end request message to the base station 330 (operation S355).

Here, a DREG-CMD message defined in the conventional IEEE 802.16e may be used as the service end response message and the handover end message. For example, whether the service end request is accepted and the handover of the mobile stations 300 and 302 is ended, may be denoted in an “Action Codes” field of the DREG-CMD message.

FIGS. 4 and 5 illustrate examples of a message format exchanged between a relay station and a base station when a handover is performed according to an embodiment of the present invention.

FIG. 4 illustrates a format example of a handover request message (an MOB_MGHO-REQ message) by which the relay station requests the base station to perform the handover, when the handover of all or some of mobile stations connected to the relay station is required. FIG. 5 illustrates a format example of a handover response message (an MOB_MGHO-RSP message) by which the base station that received the handover request message from the relay station informs the relay station whether the handover request is accepted or rejected. The aforementioned messages are transmitted by using a basic Call Identification (CID).

According to the present invention, in the case where the handover of the mobile stations connected to the relay station is required due to deregistration of the relay station, or the like, an initial connection setting procedure for entering a new network does not need to be performed, and thus a more efficient handover can be performed.

The invention can also be embodied as computer readable codes on a computer readable recording medium. The computer readable recording medium is any data storage device that can store programs or data which can be thereafter read by a computer system. Examples of the computer readable recording medium include magnetic storage media (e.g., ROM, floppy disks, hard disks, etc.), optical recording media (e.g., CD-ROMs, or DVDs), and storage media such as carrier waves (e.g., transmission through the Internet). The computer readable recording medium can also be distributed over network coupled computer systems so that the computer readable code is stored and executed in a distributed fashion.

While this invention has been particularly shown and described with reference to exemplary embodiments thereof, it will be understood by those of ordinary skill in the art that various changes in form and details may be made therein without departing from the spirit and scope of the invention as defined by the appended claims. The exemplary embodiments should be considered in a descriptive sense only and not for purposes of limitation. Therefore, the scope of the invention is defined not by the detailed description of the invention but by the appended claims, and all differences within the scope will be construed as being included in the present invention.

What is claimed is:

1. A method of ending service of a relay station in a multi-hop relay network comprising a base station, the relay station, and one or more mobile stations connected to the relay station, the method comprising:
transmitting a service end request message to the base station, wherein the transmitting is performed by the relay station;
receiving a handover end message from the base station, wherein the receiving is performed by the relay station and the handover end message indicates that a handover of the one or more mobile stations connected to the relay station is ended by the base station; and
performing a deregistration procedure, wherein the deregistration procedure is performed by the relay station.

2. The method of claim 1, wherein the service end request message comprises a handover request for the one or more mobile stations connected to the relay station.

3. The method of claim 1, further comprising, between the transmitting of the service end request message and the receiving of the handover end message,
receiving a service end response message from the base station, wherein the receiving is performed by the relay station and the service end response message indicates rejection of a service end; and
after a predetermined time, re-transmitting the service end request message to the base station, wherein the re-transmitting is performed by the relay station.

4. The method of claim 3, wherein the re-transmitting of the service end request message comprises re-transmitting the service end request message after a re-transmission time, based on information on the re-transmission time included in the service end response message indicating the rejection of the service end.

5. The method of claim 1, further comprising, between the transmitting of the service end request message and the receiving of the handover end message, receiving a service end response message from the base station, wherein the receiving is performed by the relay station and the service end response message indicates acceptance of a service end.

6. A method of deregistering a relay station in a multi-hop relay network comprising a base station, the relay station, and one or more mobile stations connected to the relay station, the method comprising:
receiving a service end request message from the relay station, wherein the receiving is performed by the base station;
performing a handover of the one or more mobile stations connected to the relay station, wherein the handover is performed by the base station; and
transmitting a handover end message to the relay station, wherein the transmitting is performed by the base station and the handover end message indicates that performing the handover of the one or more mobile stations is ended.

7. The method of claim 6, wherein the service end request message comprises a handover request for the one or more mobile stations connected to the relay station.

8. The method of claim 6, further comprising, between the receiving of the service end request message and the performing of the handover,
determining whether to accept a service end of the relay station, wherein the determining is performed by the base station; and
generating a service end response message indicating acceptance of the service end request, wherein the generating is performed by the base station, and transmitting the service end response message to the relay station.

9. The method of claim 6, further comprising, between the receiving of the service end request message and the performing of the handover, when the base station rejects the service end of the relay station, generating a service end response message including information in which a time until the relay station re-transmits the service end request message is set, and transmitting the service end response message to the relay station.

10. A method of deregistering a relay station, the method comprising:
generating a service end request message, and transmitting the service end request message to a base station, wherein the transmitting is performed by the relay station;
when the base station receives the service end request message, determining whether to accept a service end request of the relay station;
when the base station accepts the service end request of the relay station, performing a handover of all mobile stations connected to the relay station, generating a handover end message indicating that performing the handover of the mobile stations is ended, and transmitting the handover end message to the relay station; and
performing a deregistration procedure, wherein the deregistration procedure is performed by the relay station.

11. The method of claim 10, further comprising, when the base station rejects the service end request of the relay station,
generating a service end response message indicating that the service end of the relay station is rejected, and transmitting the service end response message to the relay station, wherein the transmitting is performed by the base station; and
after a predetermined time, re-transmitting the service end request message to the base station, wherein the re-transmitting is performed by the relay station.

12. A computer readable recording medium having recorded thereon a program for executing a method of deregistering a relay station in a multi-hop relay network comprising a base station, the relay station, and one or more mobile stations connected to the relay station, the method comprising:
transmitting a service end request message to the base station, wherein the transmitting is performed by the relay station;
receiving a handover end message from the base station, wherein the receiving is performed by the relay station and the handover end message indicates that a handover of the one or more mobile stations connected to the relay station is ended by the base station; and
performing a deregistration procedure, wherein the deregistration procedure is performed by the relay station.

13. The computer readable recording medium of claim 12, wherein the service end request message comprises a handover request for the one or more mobile stations connected to the relay station.

14. The computer readable recording medium of claim 12, further comprising, between the transmitting of the service end request message and the receiving of the handover end message,
receiving a service end response message from the base station, wherein the receiving is performed by the relay station and the service end response message indicates rejection of a service end request; and
after a predetermined time, re-transmitting the service end request message to the base station, wherein the re-transmitting is performed by the relay station.

15. The computer readable recording medium of claim 14, wherein the re-transmitting of the service end request message re-transmits the service end request message after a re-transmission time, based on information on the re-transmission time included in the service end response message indicating the rejection of the service end request.

16. The computer readable recording medium of claim 12, further comprising, between the transmitting of the service end request message and the receiving of the handover end message, receiving a service end response message from the base station, wherein the receiving is performed by the relay station and the service end response message indicates acceptance of a service end request.

17. A computer readable recording medium having recorded thereon a program for executing a method of deregistering a relay station in a multi-hop relay network comprising a base station, the relay station, and one or more mobile stations connected to the relay station, the method comprising:
receiving a service end request message from the relay station, wherein the receiving is performed by the base station;
performing a handover of the one or more mobile stations connected to the relay station, wherein the handover is performed by the base station; and
transmitting a handover end message to the relay station, wherein the transmitting is performed by the base station and the handover end message indicates that performing the handover of the one or more mobile stations is ended.

18. The computer readable recording medium of claim 17, wherein the service end request message comprises a handover request for the one or more mobile stations connected to the relay station.

19. The computer readable recording medium of claim 17, further comprising, between the receiving of the service end request message and the performing of the handover,
determining whether to accept a service end of the relay station, wherein the determining is performed by the base station; and
generating a service end response message indicating acceptance of the service end request, wherein the generating is performed by the base station, and transmitting the service end response message to the relay station.

20. The computer readable recording medium of claim 17, further comprising, between the receiving of the service end request message and the performing of the handover, when the base station rejects the service end of the relay station, generating a service end response message including information in which a time until the relay station re-transmits the service end request message is set, and transmitting the service end response message to the relay station.

21. A multi-hop relay system comprising:
a relay station generating and transmitting a service end request message; and
when a service end request of the relay station is accepted according to the service end request message, a base station performing a handover of all mobile stations connected to the relay station, generating a handover end message indicating that performing the handover of the mobile stations is ended, and transmitting the handover end message to the relay station,
wherein, when the relay station receives the handover end message, the relay station performs a deregistration procedure.

22. The multi-hop relay system of claim 21, wherein, when the base station rejects the service end request of the relay station, the base station generates a service end response message indicating that the service end request is rejected, and transmits the service end response message to the relay station, and
the relay station re-transmits the service end request message to the base station after a predetermined time.
